(19) United States
(12) Patent Application Publication
(10) Pub. No.: US 2025/0281879 A1
(43) Pub. Date: Sep. 11, 2025

(54) METHOD FOR SEPARATING, ENRICHING AND RECOVERING OF HE-3 FROM HE-4 AND USE OF THE SEPARATED, ENRICHED AND RECOVERED HE-3

(71) Applicant: GFZ HELMHOLTZ-ZENTRUM FUR GEOFORSCHUNG STIFTUNG DES OFFENTLICHEN RECHTS DES LANDES BRADENBURG, Potsdam (DE)

(72) Inventors: Martin ZIMMER, Schwielowsee (DE); Bettina STRAUCH, Nuthetal (DE); Samuel NIEDERMANN, Schwielowsee (DE)

(73) Assignee: GFZ HELMHOLTZ-ZENTRUM FUR GEOFORSCHUNG STIFTUNG DES OFFENTLICHEN RECHTS DES LANDES BRADENBURG, Potsdam (DE)

(21) Appl. No.: 19/070,694

(22) Filed: Mar. 5, 2025

(30) Foreign Application Priority Data
Mar. 7, 2024 (DE) 102024106605.9

(51) Int. Cl. B01D 59/26

(52) U.S. Cl. CPC B01D 59/26

(57) ABSTRACT

The invention relates to a method for removing, enriching, and acquiring the isotope ³He relative to the isotope ⁴He, comprising steps as follows:
a) performing adsorption of a ³He/⁴He-containing gas onto an adsorbent, and
b) performing selective desorption, so that ³He is released from the adsorbent.

The invention further relates to use of the removed, enriched, and acquired isotope ³He obtained by means of the method for generating a temperature in the range from 0.01 to 0.05 K, preferably of 0.02 K, or as a contrast agent for nuclear spin tomography images.

The invention relates to a method for removing, enriching, and acquiring the isotope ³He relative to the isotope ⁴He and to use of the ³He removed, enriched, and acquired.

Helium is a colorless and odorless nontoxic noble gas that remains gaseous even at low temperatures and becomes liquid only at close to absolute zero. Helium under atmospheric pressure does not become solid at absolute zero—0 K. Additionally, helium is very unreactive, and so occurs essentially only in atomic form. Helium has a number of isotopes, of which two are stable. The commonest stable isotope is ⁴He. A further stable isotope is ³He, which, however, is relatively rare as a naturally occurring isotope. ³He and ⁴He differ in their physical properties. The two isotopes therefore have different utilities.

Besides ⁴He, the lighter, stable ³He occurs primordially on the Earth, is more concentrated in the Earth's mantle, and comes to the Earth's surface in particular as a result of hot-spot volcanism. Anthropogenic ³He comes from decomposition of tritium, principally from nuclear reactors and nuclear weapons. At present only about 15 kg of ³He are acquired annually, primarily as a byproduct in the processing of nuclear weapons. Moreover, interplanetary dust and lunar regolith are more concentrated with ³He as a result of exposure to solar wind and spallation reactions of the cosmic radiation with nonvolatile particles.

In the Earth's atmosphere, there are more ⁴He atoms than ³He atoms. However, the ratio of the two isotopes varies depending on their place of origin. S. Niedermann et at. in Geochimica et Cosmochimica Acta. vol. 61. no. 13, pp. 2697-2715, 1997 describe a method for determining isotopic compositions of noble gases, in basalt glasses among other systems, wherein the isotopic compositions of the noble gases are ascertained by means of a mass spectrometer.

Given the rising consumption of ³He, there continues to be a need to remove ³He from ⁴He and to enrich it and acquire it.

It is an object of the invention to provide a method for removing, enriching, and acquiring the isotope ³He and to utilize the ³He removed, enriched, and acquired.

This object is achieved by a method having the features of claim 1 and by use having the features of claim 12. Advantageous developments and modifications are specified in the dependent claims.

The invention relates to a method for removing, enriching, and acquiring the isotope ³He relative to the isotope ⁴He, comprising steps as follows:
a) performing adsorption of a ³He/⁴He-containing gas onto an adsorbent, and
b) performing selective desorption, so that ³He is released from the adsorbent.

The method of the invention for removing, enriching, and acquiring includes a method for the isotopic separation of the isotopes ³He and ⁴He. The expression “³He/⁴He-containing gas” refers to a gas which contains ³He and ⁴He. The ³He/⁴He-containing gas preferably comprises, other than ³He and ⁴He and apart from Ne (neon), no other extraneous gases.

Preference is given to using in step a) a naturally occurring gas containing ³He and ⁴He as the ³He/⁴He-containing gas. Given that naturally occurring ³He/⁴He-containing gases always contain extraneous gases, the naturally occurring gas is preferably freed from the extraneous gases prior to the performance of step a). From nondocumentary prior art it is known practice to remove disruptive extraneous gases from the naturally occurring gas, which takes the form of a gas mixture, to give He in high purity. The naturally occurring gas mixture may be any naturally occurring gas that contains helium. For example, the naturally occurring gas may be natural gas or air. The naturally occurring gas preferably has a heightened helium content even initially. It may be volcanic gas, more preferably a hot-spot-volcanic gas, or else natural gas in certain regions. A volcanic gas typically has a higher helium content than air.

Extraneous gases such as water vapor, N₂ (nitrogen), O₂ (oxygen), H₂ (hydrogen), CO₂ (carbon dioxide), hydrocarbons, Ar (argon), Kr (krypton), and Xe (xenon) may be removed from the naturally occurring gas in the following ways, for example: Water vapor may be removed by freezing out in a component such as a pipe loop which is cooled to a predetermined temperature with a suitable refrigerant such as liquid nitrogen or dry ice. For their removal, N₂ and O₂ may each be absorbed at 400° C. on a getter charged with titanium in the form, for example, of sponges or filings. For removal from the naturally occurring gas, H₂ may be absorbed at room temperature on a getter charged with Zr—Al alloy. For their removal, CO₂ and hydrocarbons may be absorbed at 400° C. on a getter charged with Zr—Al alloy. To remove Ar, Kr, and Xe from the naturally occurring gas, they may be adsorbed for example in an adsorption cryostat on a steel frit cooled to 50 K, for example, or on an adsorption trap cooled with a suitable refrigerant such as liquid N₂ and packed with activated carbon.

In one preferred embodiment, step a) comprises performing the adsorption with activated carbon as the adsorbent at a temperature in the range from 5 K to 12 K, preferably in the range from 7 K to 11 K, more preferably at a temperature of 11 K. Step a) is carried out, for example, in a cryostat furnished with activated carbon.

Step a) is performed preferably in such a way that no gaseous phase is left. As a result, losses in this step are avoided.

In one preferred embodiment, step b) comprises gradually heating the adsorbent from a temperature in the range from 5 K to 12 K, more preferably 7 K to 11 K, more preferably 11 K, to a further temperature in the range from 13 K to 40 K. The further temperature is preferably located in the range from 15 K to 25 K, more preferably 18 K to 21 K. The isotopic separation and enrichment of ³He relative to ⁴He take place in step b). The isotopes ³He and ⁴He are released in accordance with specific desorption temperatures. Given that the van der Waals forces responsible for adsorption are comparatively weaker for ³He than for ⁴He, the former is desorbed at relatively low temperatures, whereas ⁴He is released only at higher temperatures. As a result of this physicochemical difference, ³He can be enriched relative to ⁴He in the gas phase that is released first. The gradual heating preferably comprises heating in 2 K to 8K steps, more preferably 3 K to 7 K steps, even more preferably 4 K to 6 K steps. Continuous measurement of the He isotope ratios enables optimal helium fractionation conditions and temperatures to be ascertained as a function of the ³He/⁴He-containing gas used. The ³He-enriched gas fraction is preferably transferred in accordance with a step c) into an isolated reservoir and thus removed from the rest of the system, so that subsequently, on further increase in temperature, there is no renewed mixing with gas having a lower ³He concentration.

Alternatively, in a further variant, step a) comprises ionizing and injecting the ³He/⁴He-containing gas into an ion getter as the adsorbent at a temperature in the range of 280 K to 315 K, preferably 285 K to 305 K, more preferably 290 K to 295 K. For simplicity, in the further variant, step a) is performed preferably at room temperature.

The ion getter preferably comprises a metal. The metal is preferably barium, more preferably titanium.

In one preferred embodiment, in the further variant, step b) comprises gradually heating the adsorbent from a temperature up to a range from 500 K to 700 K, preferably 550 K to 650 K, more preferably 575 K to 625 K. During the graduated or gradual heating to the aforesaid temperatures, the two helium isotopes ³He and ⁴He are released from the ion getter in accordance with the specific desorption temperatures. Without wishing to be tied to one theory, it is assumed that ³He is adsorbed comparatively less strongly in the ion getter and is desorbed at relatively low temperatures, whereas ⁴He is released to a greater extent only at higher temperatures. The continuous measurement of the He isotope ratios enables optimal helium fractionation conditions and temperatures to be ascertained as a function of the ³He/⁴He-containing gas used. The gradual heating preferably comprises heating in 2 K to 8K steps, more preferably 3 K to 7 K steps, even more preferably 4 K to 6 K steps. The gas fraction with a preferably high ³He/⁴He ratio and a preferably large gas quantity is preferably transferred in accordance with step c) into an isolated reservoir and thus removed from the rest of the system, so that subsequently there is no renewed mixing with gas having a lower ³He concentration.

In one preferred embodiment, the method further comprises the step c) of transferring the ³He released in step b) into an isolated reservoir. In this case, a gas fraction enriched with ³He and still also containing ⁴He is transferred into the isolated reservoir. Step c) may be carried out during and/or subsequent to step b). Step c) is preferably carried out during step b), so as to fractionate a gas fraction enriched with ³He and having a high and/or the highest ³He/⁴He ratio and to isolate this fraction from gas fractions having a lower ³He/⁴He ratio. The isolated reservoir constitutes a reservoir which is physically isolated from an apparatus and in which step b) is performed.

Preferably, steps a) and b) and optionally c) are multiply repeated. Repeating the method steps a number of times allows ³He to be increasingly enriched relative to ⁴He and acquired. The gas fraction enriched with ³He preferably has a high and/or highest ³He/⁴He ratio and steps a), b), and optionally c) are preferably repeated until a predetermined ³He concentration is reached.

In one preferred embodiment, the ³He/⁴He-containing gas mixture comprises an at least 1.2-fold, more preferably at least 1.5-fold, enrichment of ³He relative to the ³He/⁴He-containing gas mixture used in step a).

The ³He/⁴He ratio in the gas phase in step b) is preferably measured continuously by means of a mass spectrometer. Continuous measurement of the He isotope ratios enables optimal helium fractionation conditions and temperatures to be ascertained as a function of the ³He/⁴He-containing gas used.

The invention further relates to use of the removed, enriched, and acquired isotope ³He obtained by means of the method according to one or more of the above-described embodiments for generating a temperature in the range from 0.01 to 0.05 K, preferably of 0.02 K, or as a contrast agent for nuclear spin tomography images. This produces an improvement in the supply of ³He for research laboratories and in particular for medical engineering.

The ³He is used preferably in scientific laboratories for generating extremely low millikelvin temperatures such as 0.02 K, for example, by dissolving liquid ³He in liquid ⁴He. Among its preferential functions is the cooling of superconducting magnets.

Hyperpolarized ³He is used preferably in diagnostics as a contrast agent for nuclear spin tomography images. In the case of medical imaging techniques, hyperpolarized ³He acts, for example, as an image improver in the imaging of brain and lung.

The invention is additionally elucidated in more detail below in relation to figures and an example. Schematically and not to scale,

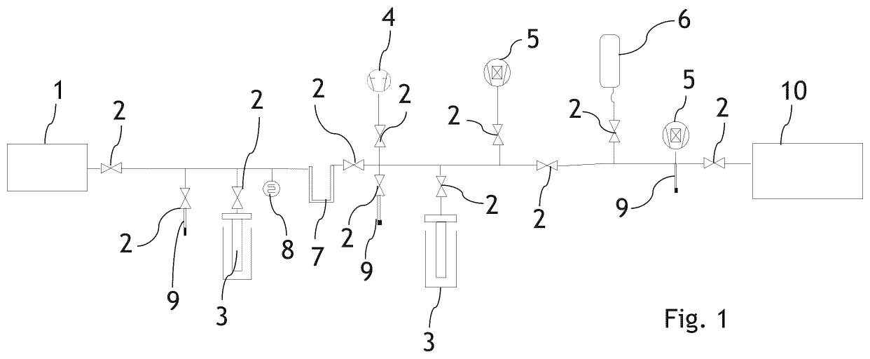

FIG. 1 shows an outline representation of a plant in which a method according to a first embodiment is carried out; and

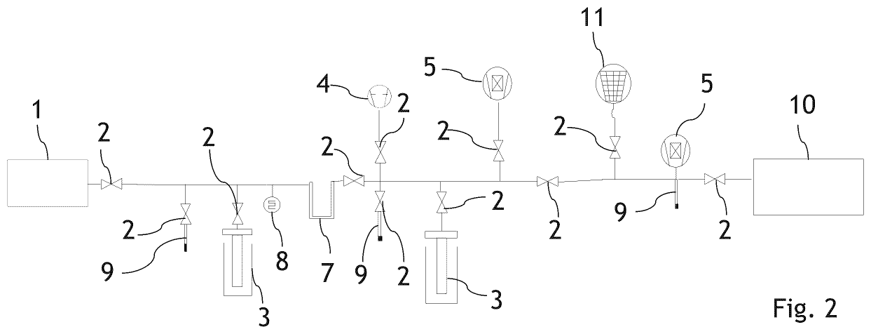

FIG. 2 shows an outline representation of a further plant, in which a method according to a second embodiment is carried out.

FIG. 1 shows an outline representation of a plant in which a method according to a first embodiment is carried out. The method is practiced on a ³He/⁴He-containing gas, which is a naturally occurring gas in the form of a gas mixture. The natural gas is supplied to the plant via a gas inlet 1, which comprises multiple valves 2 for shutting off or controlling a flow of the naturally occurring gas through the plant. The plant optionally comprises a Pirani measurement branch 8 for the pressure measurement of coarse and/or fine vacuum. In addition, optionally, the plant comprises facilities for removing extraneous gases from the ³He/⁴He-containing gas, so that the method of the invention is practiced on a mixture of ³He/⁴He in high purity, in which Ne (neon) is the only extraneous gas. For the removal of the extraneous gases with the exception of Ne, there are activated carbon traps 9, a cold trap 7, getters 3 (e.g., Ti getters), SAES getters and/or SAES pumps 4 and further SAES getters and/or SAES pumps 5, which are available commercially from SAES (Societa Apparecchi Elettrici e Scientifici (Lainate, Italy); the extraneous gases may be, for example, water vapor, N₂ (nitrogen), O₂ (oxygen), H_{z}(hydrogen), CO₂ (carbon dioxide), hydrocarbons, Ar (argon), Kr (krypton) and/or Xe (xenon). The method of the invention comprises performing adsorption of a ³He/⁴He-containing gas on an adsorbent and is performed in a cooling head 6 charged with activated carbon.

The activated carbon is the adsorbent. The adsorption with activated carbon as the adsorbent in the cooling head 6 charged with activated carbon is performed at a temperature of 11 K, for example. The adsorption is performed in such a way that no gaseous phase is left. Following the adsorption, a selective desorption is carried out, so that ³He is released from the adsorbent. As a result, the ³He is removed from the ⁴He, enriched, and acquired. The selective desorption is accomplished by gradual heating of the adsorbent, i.e., the activated carbon, from the temperature of 11 K to a temperature of 20 K, for example. Under these conditions, Ne remains adsorbed on the adsorbent.

The ³He/⁴He ratio may be measured continuously by means of a mass spectrometer 10. The ³He-enriched gas fraction released is transferred into an isolated reservoir. The adsorption and selective desorption with the gas fraction removed in the preceding step with preferably high ³He/⁴He ratio and preferably large gas quantity may be performed with multiple repetition, so that ³He is further enriched relative to ⁴He and acquired.

FIG. 2 shows an outline representation of a further plant, in which a method according to a second embodiment is carried out. The further plant shown in FIG. 2 corresponds to the plant shown in FIG. 1, with the difference that it comprises an ion getter pump 11 instead of the cooling head charged with activated carbon. The ion getter comprises a metal such as titanium. The method according to the second embodiment comprises the adsorption of a ³He/⁴He-containing gas on an adsorbent and the selective desorption, so that ³He is released from the adsorbent; the adsorption is performed by means of ionizing and injecting the ³He/⁴He-containing gas into an ion getter as the adsorbent at a temperature which is, for example, room temperature. The selective desorption is realized by gradual heating of the adsorbent, i.e., the ion getter, to a temperature of, for example, 600 K. The ³He-enriched gas fraction released by means of the desorption is transferred into an isolated reservoir. The adsorption and selective desorption with the gas fraction removed in the preceding step with the highest ³He/⁴He ratio may be performed with multiple repetition, so that ³He is further removed and enriched relative to ⁴He and acquired.

### EXAMPLE

A single-stage test series was performed using a naturally occurring gas freed from extraneous gases, in the form of a gas having a ³He/⁴He ratio of (21.66±0.24)×10⁻⁶, which corresponds to a typical value for a gas resulting from hot-spot volcanism.

First, adsorption of the ³He/⁴He-containing gas on an adsorbent in the form of activated carbon was performed. The adsorption with activated carbon as the adsorbent may be performed, for example, in the cooling head charged with activated carbon that is shown in FIG. 1, at a temperature of 11 K, so that no gaseous phase is left. Following the adsorption, a selective desorption is carried out, so that ³He is released from the adsorbent. The selective desorption is realized by gradual heating of the adsorbent, i.e., the activated carbon, from the temperature of 11 K to a temperature of, for example, 20 K. The gradual heating may be carried out in 5 K steps, for example. Under these conditions, Ne remains adsorbed on the adsorbent. A ³He/⁴He ratio may be measured continuously by means of the mass spectrometer shown in FIG. 1.

The helium isotopes were measured in a VG5400 90°-sector mass spectrometer from Vacuum Generators Instruments, now Thermo Fisher Scientific (Waltham, USA). Table 1 shows ⁴He signals and measured ³He/⁴He ratios with 2sigma error of the desorbed gas phase at different temperatures:

| Temperature (K) | He (volts) | ³He/⁴He (10⁻⁶) |
|---|---|---|
| 15 | 0.001278 | 34 ± 14 |
| 20 | 0.076970 | 34.5 ± 1.3 |
| 25 | 0.97230 | 24.82 ± 0.52 |
| 30 | 0.86159 | 17.71 ± 0.40 |
| 35 | 0.115312 | 15.98 ± 0.67 |
| 40 | 0.008314 | 16.6 ± 3.2 |

At a temperature of 20 K, in particular, ³He was enriched 1.5-fold relative to ⁴He. In particular, the gas fraction enriched in ³He at 20 K was transferred into an isolated reservoir. A further enrichment in ³He can be achieved by optimizing the step increment and by multistage isotopic separation, i.e., repetition of the absorption and selective desorption of the gas fraction removed in the preceding step, with preferably high ³He/⁴He ratio and preferably large gas quantity.

### LIST OF REFERENCE SIGNS

1 gas inlet
2 valve
3 getter
4 SAES pump
5 further SAES pump
6 cooling head charged with activated carbon
7 cold trap
8 Pirani measurement branch
9 activated carbon trap
10 mass spectrometer
11 ion getter pump

1. A method for removing, enriching, and acquiring the isotope ³He relative to the isotope ⁴He, comprising steps as follows:
a) performing adsorption of a ³He/⁴He-containing gas onto an adsorbent, and
b) performing selective desorption, so that ³He is released from the adsorbent.

2. The method as claimed in claim 1, wherein step a) comprises performing the adsorption with activated carbon as the adsorbent at a temperature in the range from 5 K to 12 K, preferably in the range from 7 K to 11 K, more preferably at a temperature of 11 K.

3. The method as claimed in claim 1, wherein step a) is performed in such a way that no gaseous phase is left.

4. The method as claimed in claim 1, wherein step b) comprises gradually heating the adsorbent from a temperature in the range from 5 K to 12 K, preferably 7 K to 11 K, more preferably 11 K, to a temperature in the range from 13 K to 40 K, preferably 15 K to 25 K, more preferably 18 K to 21 K.

5. The method as claimed in claim 1, wherein step a) comprises ionizing and injecting the ³He/⁴He-containing gas into an ion getter as the adsorbent at a temperature in the range of 280 K to 315 K, preferably 285 K to 305 K, more preferably 290 K to 295 K.

6. The method as claimed in claim 5, wherein the ion getter comprises a metal, preferably barium, more preferably titanium.

7. The method as claimed in claim 5, wherein step b) comprises gradually heating the adsorbent from a temperature up to a range from 500 K to 700 K, preferably 550 K to 650 K, more preferably 575 K to 625 K.

8. The method as claimed in claim 1, comprising a step c) of transferring the ³He released in step b) into an isolated reservoir.

9. The method as claimed in claim 1, wherein steps a) and b) and, if dependent from claim 8, step c) are multiply repeated.

10. The method as claimed in claim 1, wherein the ³He/⁴He-containing gas mixture obtained according to step b) comprises an at least 1.2-fold, preferably at least 1.5-fold, enrichment of ³He relative to the ³He/⁴He-containing gas mixture used in step a).

11. The method as claimed in claim 1, wherein the ³He/⁴He ratio in the gas phase in step b) is measured continuously by means of a mass spectrometer (10).

12. The use of the removed, enriched, and acquired isotope ³He obtained by means of the method as claimed in claim 1 for generating a temperature in the range from 0.01 to 0.05 K, preferably of 0.02 K, or as a contrast agent for nuclear spin tomography images.
